(19) United States
(12) Patent Application Publication
(10) Pub. No.: US 2020/0284285 A1
(43) Pub. Date: Sep. 10, 2020

(54) SCREW

(71) Applicant: TENG-HUNG LIN, Kaohsiung City (TW)

(72) Inventor: TENG-HUNG LIN, Kaohsiung City (TW)

(21) Appl. No.: 16/292,351

(22) Filed: Mar. 5, 2019

(51) Int. Cl. F16B 25/00; F16B 25/10

(52) U.S. Cl. CPC F16B 25/0057; F16B 25/106

(57) ABSTRACT

A screw includes a head, a rod extending from a lower end of the head and a tapered drilling portion extending from a lowest end of the rod; the rod having a normal thread with a predetermined length; the normal thread extending from a lower end of the head to the tapered drilling portion, but having a predetermined distance from a tip end of the tapered drilling portion; an umbrella thread extending from a lower end of the normal thread to the tip end of the tapered drilling portion; the umbrella thread being formed by an upper thread surface and a lower thread surface. A second angle between the upper thread surface of the normal thread and the lower thread surface of the normal thread becomes larger and larger from the end near the normal thread to an end near the tip end.

### FIELD OF THE INVENTION

The present invention is related to screws, and in particular to a screw which is effectively in drilling operation.

### BACKGROUND OF THE INVENTION

Generally, screws are used in many different fields, however, designs of screws considers the factors, such as drilling speed, drag removing, and final retaining effect. To achieve above objects, various screws are developed, such as single stage screws, two stage screws, or same guiding angles, and different guiding angles, etc.

Similarly, in designing threads of screws, properties of the combining materials with the screw are also taken into consideration. For example, for drilling a screw to a plaster plates or thin iron plates, etc, the screw is driven into the plates by a driving gun in one side, while it is possible that the plates explode in another side so that the gaps between plate and the screw are larges and thus the combining force is weak.

The inventor of the present invention ever developed a novel screw which can improve above mentioned defects effectively. In the prior art, the screw rod includes two sections which have threads thereon. A second thread near a distal dip end of the screw is formed by an upper thread surface and a lower thread surface. An angle between the upper thread surface and the lower thread surface is greater than 90 degrees. The second thread extends to the distal tip end of the screw. However, this prior art structure is difficult to shape and the distal end is not uniform and smooth, as a result, the screwing speed of the screw in drilling an object is not regular and uniform so as to affect the operation of the screw.

Therefore, it has an eager demand for a novel screw which is easy to shape in manufacturing process and the tip end of the screw is uniform and smooth so that in drilling, the screw has a uniform speed and is quick in drilling operation.

### SUMMARY OF THE INVENTION

Accordingly, for improving above mentioned defects in the prior art, the object of the present invention is to provide a screw, wherein the structure of the screw is easily in manufacturing. The tip end of the screw has a uniform structure. Furthermore in drilling, the screw has a uniform speed and is quick in drilling operation.

To achieve above objects, the present invention provides a screw comprising: a head (11), a rod (12) extending from a lower end of the head (11) and a tapered drilling portion (13) extending from a lowest end of the rod (12); the rod (12) having a normal thread (2) with a predetermined length; the normal thread (2) extending from a lower end of the head (11) to the tapered drilling portion (13, but having a predetermined distance from a tip end (131) of the tapered drilling portion (13); an umbrella thread (13) extending from a lower end of the normal thread (2) to the tip end (131) of the tapered drilling portion (13); the umbrella thread (13 being formed by an upper thread surface (2A) and a lower thread surface (2B); wherein a second angle between the upper thread surface (2A) of the normal thread (2) and the lower thread surface (2B) of the normal thread (2) becomes larger and larger from the end near the normal thread (2) to an end near the tip end (131).

A first angle between the upper thread surface (2A) of the normal thread (2) and the lower thread surface (2B) of the normal thread (2) is smaller than 90 degrees. A second angle between the upper thread surface (2A) of the normal thread (2) and the lower thread surface (2B) of the normal thread (2) is smaller than 90 degrees at an end near the normal thread (2); and at the end near the tip end (131), the second angle is greater than 90 degrees, while a slope of the upper surface (2A) of the umbrella thread (13 with respective to an axle of the tapered drilling portion (13) is unchanged.

### BRIEF DESCRIPTION OF THE DRAWINGS

FIG. 1 shows the embodiment of the present invention.

FIG. 2 is an enlarged cross section view of the present invention.

### DETAILED DESCRIPTION OF THE INVENTION

In order that those skilled in the art can further understand the present invention, a description will be provided in the following in details.

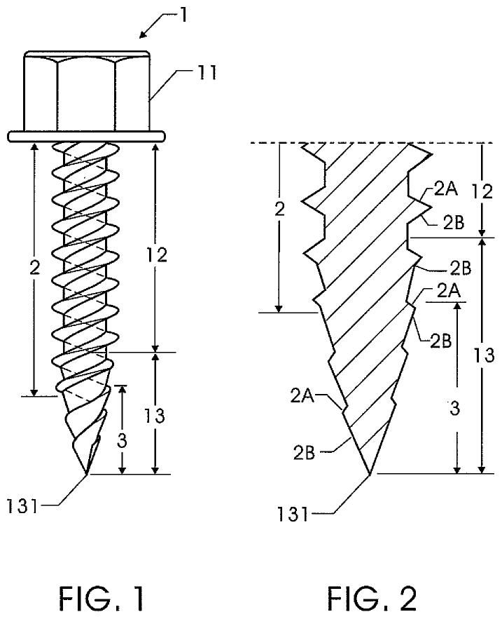

However, these descriptions and the appended drawings are only used to cause those skilled in the art to understand the objects, features, and characteristics of the present invention, but not to be used to confine the scope and spirit of the present invention defined in the appended claims. With reference to FIGS. 1 and 2, the structure of the present invention is illustrated. The screw 1 of the present invention includes a head 11, a rod 12 extending from a lower end of the head 11 and a tapered drilling portion 13 extending from a lowest end of the rod 12. The rod 12 has a normal thread 2 with a predetermined length. The normal thread 2 extends from the head 11 to the tapered drilling portion 13, but has a predetermined distance from a tip end 131 of the tapered drilling portion 13. The normal thread 2 is formed by an upper thread surface 2A and a lower thread surface 2B. A first angle between the upper thread surface 2A of the normal thread 2 and the lower thread surface 2B of the normal thread 2 is smaller than 90 degrees.

As illustrated in the drawing, an umbrella thread 13 extends from a lower end of the normal thread 2 to the tip end 131 of the tapered drilling portion 13. The umbrella thread 13 is formed by an upper thread surface 2A and a lower thread surface 2B. a second angle between the upper thread surface 2A of the normal thread 2 and the lower thread surface 2B of the normal thread 2 is smaller than 90 degrees at an end of the umbrella thread 13 near the normal thread 2, and the second end become larger and larger from the end near the normal thread 2 to an end near the tip end 131. At the end near the tip end 131, the second angle is greater than 90 degrees, while a slope of the upper surface 2A of the umbrella thread 13 with respect to an axle of the tapered drilling portion 13 is unchanged.

In another example, there is another normal thread 2 which is parallel arranged with the normal thread 2, and there is another umbrella thread 13 which is parallel arranged with the umbrella thread 13

From above said structure, it is known that the structure of the screw is easily in manufacturing. The tip end of the screw has a uniform structure. Furthermore in drilling, the screw has a uniform speed and is quick in drilling operation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw comprising:
a head (11),
a rod (12) extending from a lower end of the head (11) and
a tapered drilling portion (13) extending from a lowest end of the rod (12); the rod (12) having a normal thread (2) with a predetermined length;
the normal thread (2) extending from a lower end of the head (11) to the tapered drilling portion (13), but having a predetermined distance from a tip end (131) of the tapered drilling portion (13);
an umbrella thread (13) extending from a lower end of the normal thread (2) to the tip end (131) of the tapered drilling portion (13); the umbrella thread (13) being formed by an upper thread surface (2A) and a lower thread surface (2B);
wherein a second angle between the upper thread surface (2A) of the normal thread (2) and the lower thread surface (2B) of the normal thread (2) becomes larger and larger from the end near the normal thread (2) to an end near the tip end (131).

2. The screw as claimed in claim 1, wherein the normal thread (2) is formed by an upper thread surface (2A) and a lower thread surface (2B); a first angle between the upper thread surface (2A) of the normal thread (2) and the lower thread surface (2B) of the normal thread (2) is smaller than 90 degrees.

3. The screw as claimed in claim 2, wherein the second angle between the upper thread surface (2A) of the normal thread (2) and the lower thread surface (2B) of the normal thread (2) is smaller than 90 degrees at an end near the normal thread (2); and at the end near the tip end (131), the second angle is greater than 90 degrees, while a slope of the upper surface (2A) of the umbrella thread (13 with respective to an axle of the tapered drilling portion (13) is unchanged.

4. The screw as claimed in claim 1, wherein there is another normal thread (2) which is parallel arranged with the normal thread (2), and there is another umbrella thread (13) which is parallel arranged with the umbrella thread (13).
